(19) United States
(12) Patent Application Publication
(10) Pub. No.: US 2025/0047087 A1
(43) Pub. Date: Feb. 6, 2025

(54) ELECTRICAL POWER DISTRIBUTION SYSTEM

(71) Applicant: Norman R. Byrne, Ada, MI (US)

(72) Inventors: Parker Genau, Grand Rapids, MI (US); Marc A. Mitchell, Jupiter, FL (US)

(21) Appl. No.: 18/790,078

(22) Filed: Jul. 31, 2024

Related U.S. Application Data
(60) Provisional application No. 63/516,562, filed on Jul. 31, 2023.

(51) Int. Cl. H02G 3/30; B65G 23/22; H01R 13/447; H02G 5/04

(52) U.S. Cl. CPC H02G 3/30; B65G 23/22; H01R 13/447; H02G 5/04

(57) ABSTRACT

A modular electrical distribution system, such as for powering an electrical conveyor, includes a conductor section, a movable cover, a branch coupler, and a power supply cord. The conductor section has a pair of opposing end connectors that are compatible with one another so that two or more conductor sections can be attached end-to-end. The conductor section further includes an intermediate connector disposed between opposing end connectors for receiving a plug of the branch coupler. A movable cover can be moved over the intermediate connector to prevent intrusion of contaminants and preclude access to live electrical contacts. The plug can engage the intermediate connector when the cover is displaced away from the intermediate connector.

### CROSS REFERENCE TO RELATED APPLICATION

The present application claims the benefit of U.S. provisional application Ser. No. 63/516,562, filed Jul. 31, 2024, which is here by incorporated herein by reference in its entirety.

### FIELD

The present application relates to electrical power distribution systems, in particular adaptable power distribution systems for use in material handling conveyor systems.

### BACKGROUND

Belt and roller conveyors are used to efficiently move parcels and other materials throughout a facility, from an intake area to a desired output area. Different conveyor sections are arranged to provide a desired length and route of a conveyor path, or a desired assortment of paths, and may be straight and/or of different lengths, curved, and/or capable of sorting or directing parcels in different directions. Typically the conveyors are electrically powered, such as with DC electrical motors in or associated with one or more rollers of a given conveyor section, with AC power being supplied to a DC converter circuit near the conveyors. The associated electrical systems may be exposed to heat, dust, liquid spills, and other environmental factors, often for 24 hours per day, 7 days per week except during maintenance intervals. Because conveyor layouts may change according to a facility's changing needs, it is useful to provide an electrical power system for the conveyors that has adaptability and resistance to the environmental factors that are commonly found in conveyor facilities.

### SUMMARY

The present invention provides an environmentally sealed or protected electrical distribution system for low voltage DC power, for use in adaptable electrical environments such as conveyor facilities. The electrical distribution system is “directional” in that each main component has compatible connectors at each opposite end, which allow only the compatible ends (and not identical ends) to be coupled together. One or more intermediate connection points can allow for multiple power connections along the system, and can accommodate different lengths of cords without excessive slack or tension in the cords. The system may utilize snap-together retainers that are difficult to separate by hand, so that a tool may be needed to release any latches associated with electrical connections, reducing the risk of inadvertent or mistaken separation of electrical connections. Additional covers may be provided for any electrical terminals not being utilized in a given configuration.

In one form, the electrical distribution system is a modular system that includes a conductor section, a movable cover, a branch coupler, and a power supply cord. The conductor section has a pair of opposing end connectors that are compatible with one another, which would allow multiple conductor sections to be attached end-to-end. The conductor section further includes an intermediate connector between opposing end connectors, to receive a plug of the branch coupler. A cover can be moved over the intermediate connector to prevent intrusion of contaminants and preclude access to live electrical contacts, and the plug can engage the intermediate connector when the cover is displaced away from the intermediate connector.

Thus, the electrical distribution system provides adaptability for supplying electrical power, such as to an electrical conveyor system, while further providing built-in covers and other protections for both connectors that are actively in use, and those that are not currently in use.

These and other objects, advantages, purposes and features of this invention will become apparent upon review of the following specification in conjunction with the drawings.

### BRIEF DESCRIPTION OF THE DRAWINGS

FIG. 1 is a perspective view of a low voltage DC distribution system with end-to-end interfaces;

FIGS. 1A and 1B are enlarged views of male and female connector interfaces in the area designated “1A, 1B” in FIG. 1;

FIG. 2 is a perspective view of another set of male and female end-to-end connector interfaces of a low voltage DC distribution system similar to that of FIG. 1;

FIG. 3 is a perspective view of a male plug terminal compatible for use with the low voltage DC distribution system of FIG. 2;

FIG. 4 is a set of views of different tamper-resistant features that may be implemented with the female connectors of the low voltage DC distribution systems of FIGS. 1 and 2;

FIG. 5 is a perspective view of another set of male and female connector interfaces of a low voltage DC distribution system with end-to-end interfaces;

FIG. 6 is a perspective view depicting a user preparing to manually connect the male and female connector interfaces of the low voltage DC distribution system of FIG. 5;

FIG. 7 is a perspective view of the end of the male connector interface of the low voltage DC distribution system of FIG. 5, including environmental-resistant and tamper-resistant shutters that limit access to male blade terminals contained inside;

FIG. 8 is a partial-cutaway side elevation view depicting the initial insertion angle of the female connector interface (right) to the male connector interface (left);

FIG. 9 is a side elevation view of the male and female connector interfaces of the low voltage DC distribution system of FIG. 5;

FIG. 10 is a side elevation view of another male and female connector interface utilizing sloped connector insulator surfaces and U-shaped terminals;

FIG. 11 is a perspective view of a male plug for receiving power from one of the power distribution system sections;

FIG. 12 is a perspective view of one of the power distribution system sections of the low voltage DC distribution system of FIG. 5, shown with the male plug of FIG. 11 prior to engagement with a female receiving receptacle along the section;

FIG. 13 is a partially-exploded perspective view of another low voltage DC distribution system with end-to-end interfaces and four branch power couplers;

FIG. 14 is a perspective view of the low voltage DC distribution system of FIG. 13 shown with one branch power coupler and fitted to a conveyor system rail; and

FIG. 15 is an enlarged view of connector components of the low voltage DC distribution system of FIG. 13.

### DESCRIPTION OF THE PREFERRED EMBODIMENTS

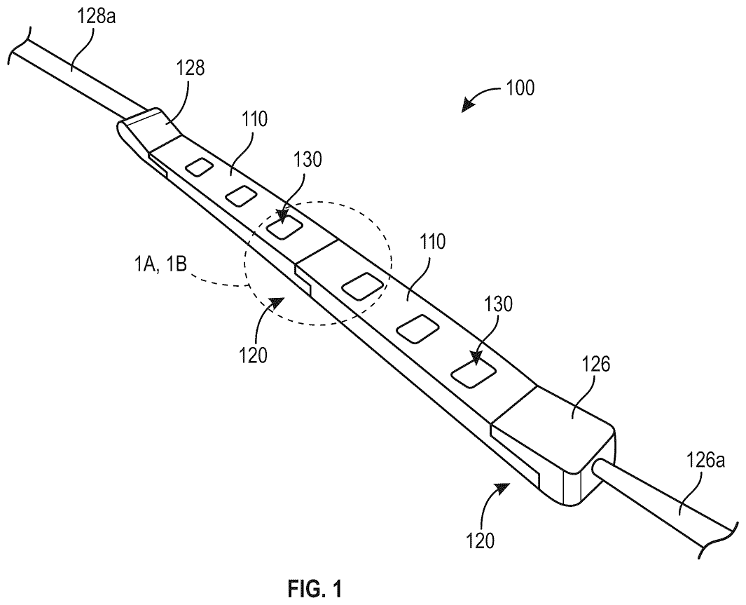

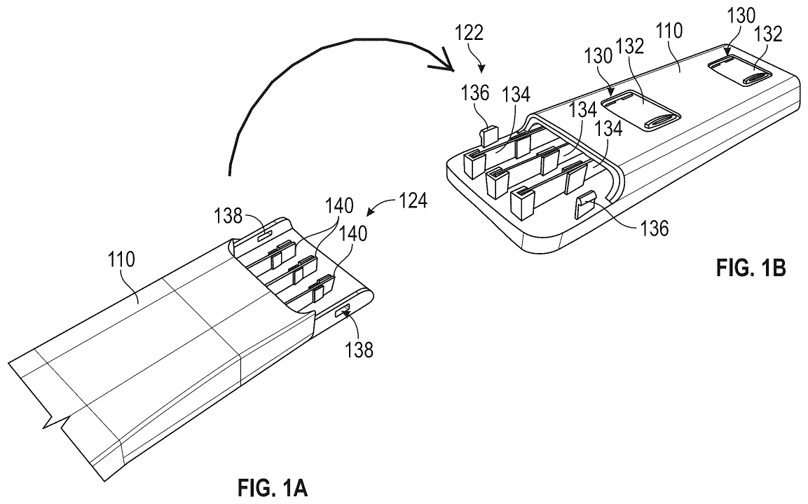

Referring now to the drawings and illustrative embodiments depicted therein, a low voltage DC distribution system 100 has a series of runs or sections 110 with end-to-end overlapping connector interfaces 120, which are formed by overlapping a male bus bar terminal end 122 with a female bus bar terminal end 124 (FIGS. 1-1B). A compatible power input 126 with cord 126a and compatible power output 128 with cord 128a (FIG. 1) may be connected to sections 110 if flexible cord sections are desired, such as for runs between adjacent or nearby conveyor sections that are movable relative to one another, or that are not rigidly coupled to one another. In the illustrated embodiment of FIG. 1, and as also shown in FIG. 1B, each section 110 includes a series of spaced-apart openings 130 that are fitted with slide shutters or caps 132 (FIG. 1B) that can be removed or displaced in order to provide access to intermediate connectors in the form of female terminals along the bus bars, for engagement by male prongs of another connector, as will be described below. Male bus bar end 122 (FIG. 1B) supports at least two bus bars 134 that are exposed, and has latch tabs 136 used for releasably engaging corresponding latch receivers 138 of the female bus bar end 124 (FIG. 1A). Female bus bar end 124 supports the opposite ends of the bus bars 134, with female terminals 140 at their ends for engaging the corresponding bus bars 134 at the male bus bar end 122 of another section 110. The bus bar ends 122, 124 are shaped to overlap one another while maintaining a consistent outer profile shape to substantially enclose the bus bar ends when assembled together at the interfaces 120, such as shown in FIG. 1.

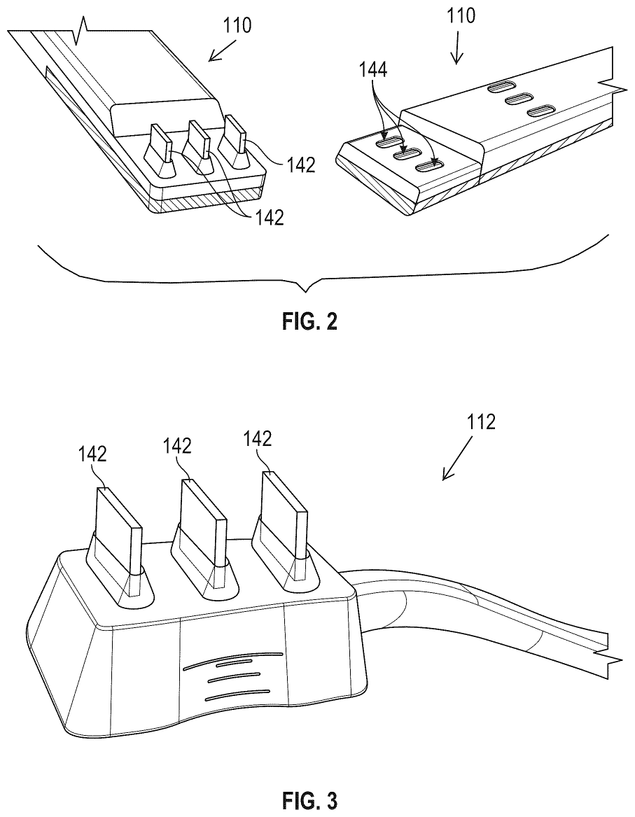

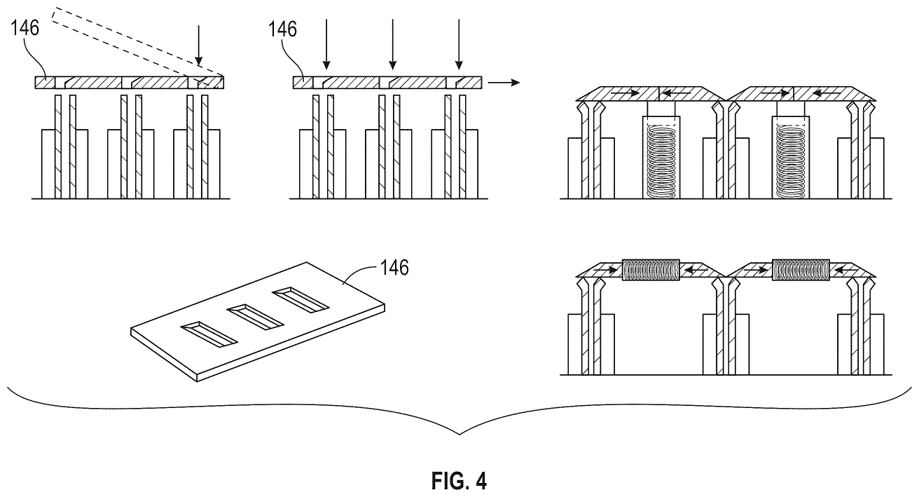

Different connector interfaces are envisioned, such as those of FIGS. 2 and 3 in which male blade terminals 142 of a branch coupler 112 or a bus bar section 110 project outwardly and female terminals are recessed behind female terminal openings 144, which may be fitted with flexible or mechanical shutters to provide tamper resistance and some degree of resistance to environmental contaminants. Examples of slide shutters and tilt shutters are shown in FIG. 4, with a three-opening shutter plate 146 depicted in the three drawings at left, and spring-loaded two-piece shutters with springs depicted in the drawings at right. Shutter plate 146 may be made of a flexible or resilient material, or may have a relatively soft outer coating, to enhance its sealing properties. Other types of tamper-resistant mechanisms are described in commonly-owned U.S. Pat. No. 9,059,530, issued Jun. 16, 2015, and U.S. Pat. No. 11,139,611, issued Oct. 5, 2021, both of which are hereby incorporated herein by reference in their entireties.

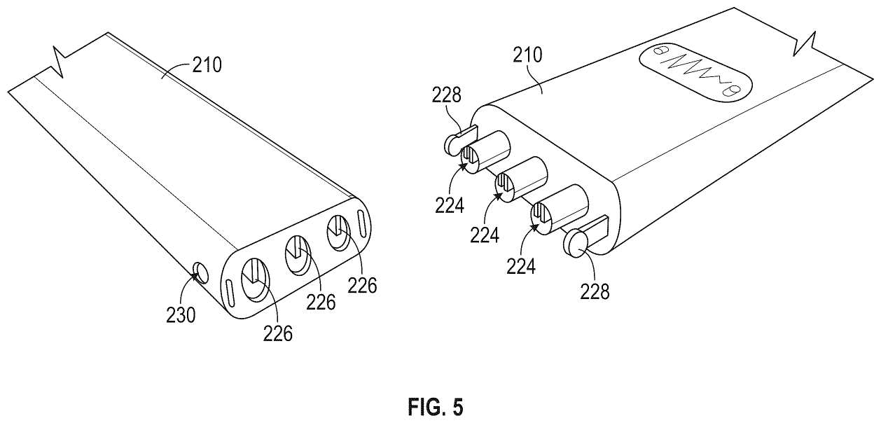

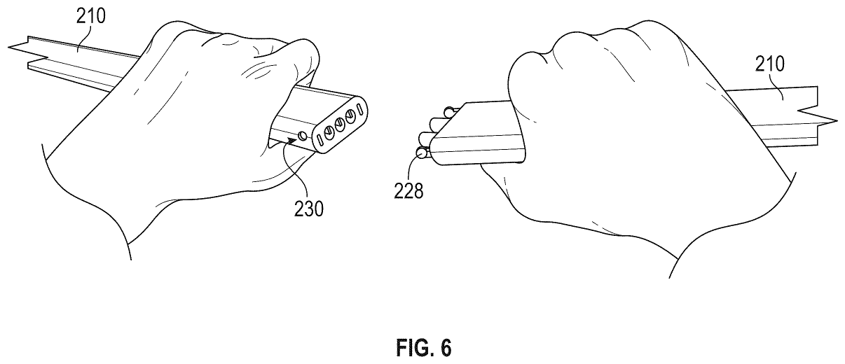

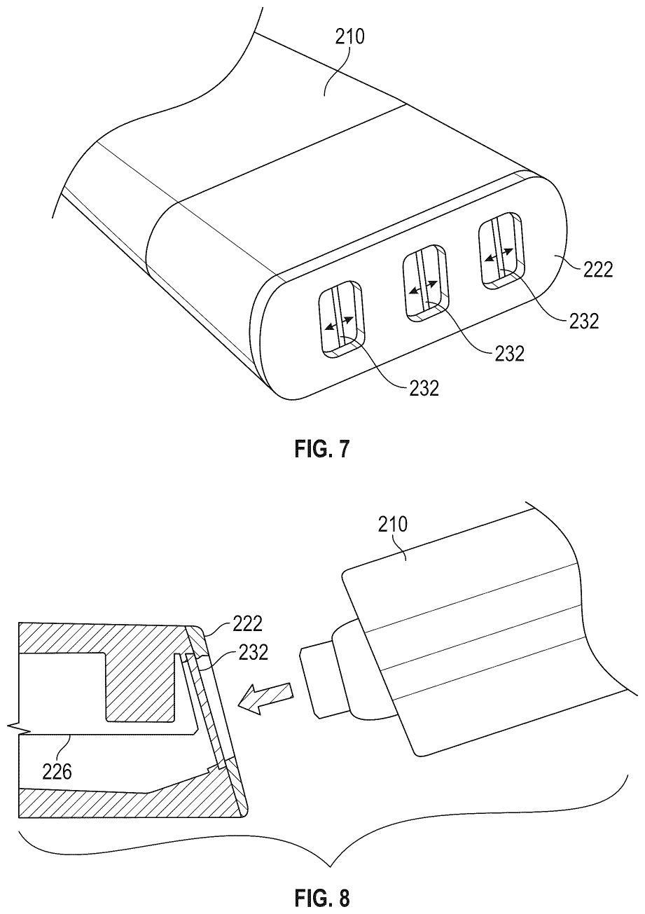

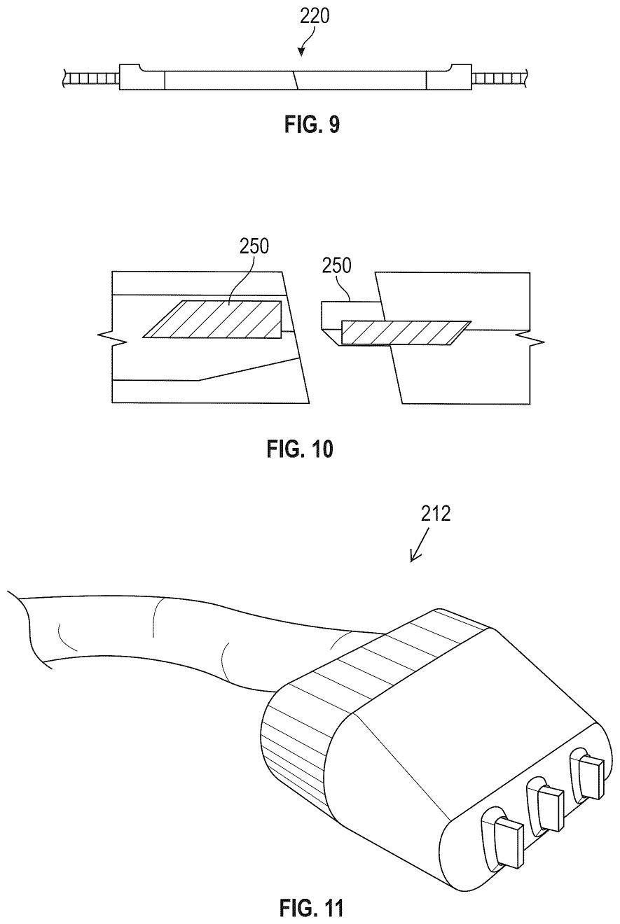

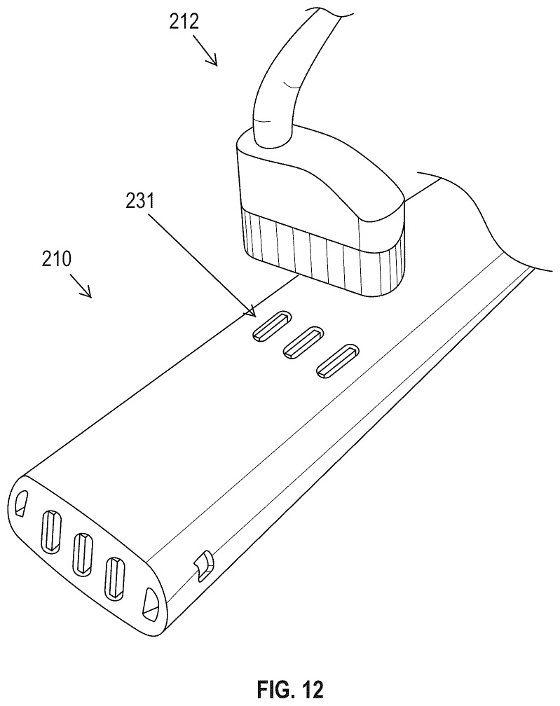

Referring to FIGS. 5-9, another low voltage DC distribution system 200 has a series of runs or sections 210 with abutting connector interfaces 220, which are initially engaged at a non-parallel angle (FIGS. 6, 8, and 9). This causes a soft sealing gasket 222 (FIGS. 7 and 8) to initially deform. After initial engagement at a non-parallel angle, the sections 210 are straightened into parallel alignment (FIG. 9), which causes female terminals 224 to fully seat with male terminals 226, while also fully engaging and latching a pair of latch tabs 228 (FIG. 6) to engage latch receivers 230. The sections 210 further include intermediate connector opening sets 231 that can be engaged by a branch coupler 212 (FIGS. 11 and 12). The electrical connections may instead be established by overlapping a male bus bar end 122 with a female bus bar terminal end 124, such as shown in FIGS. 1-1B. Optional shutters 232 (FIG. 7) limit access to male terminals 226. Male and female connectors, shown in FIGS. 11 and 12, are substantially similar to those described above with respect to FIGS. 1-3. Other types of electrical contacts are envisioned, such as compatible U-shaped terminals 250 (FIG. 10) that can connect together, optionally with the U-shaped terminals formed identically to one another and therefore establishing an interference fit when engaged together, with one or both terminals 250 deforming resiliently to permit the connection.

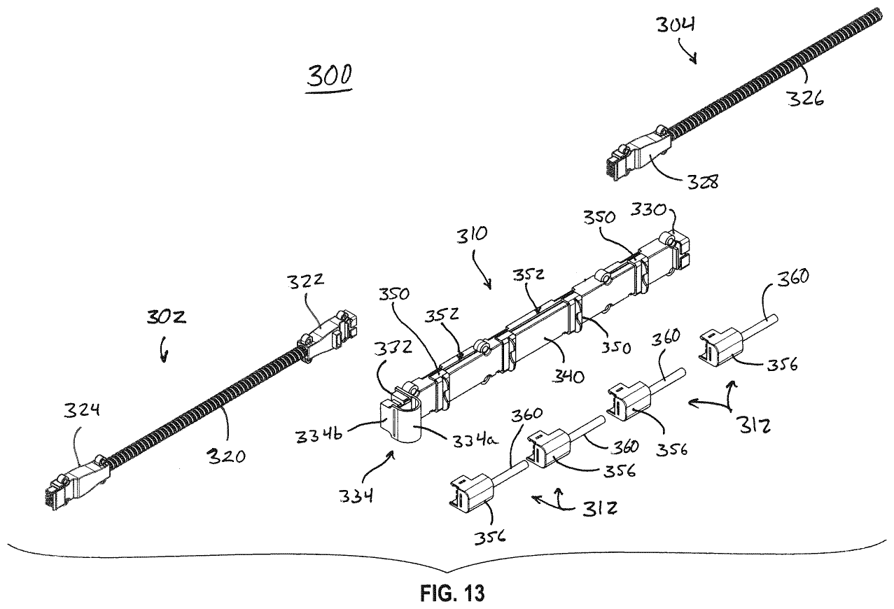

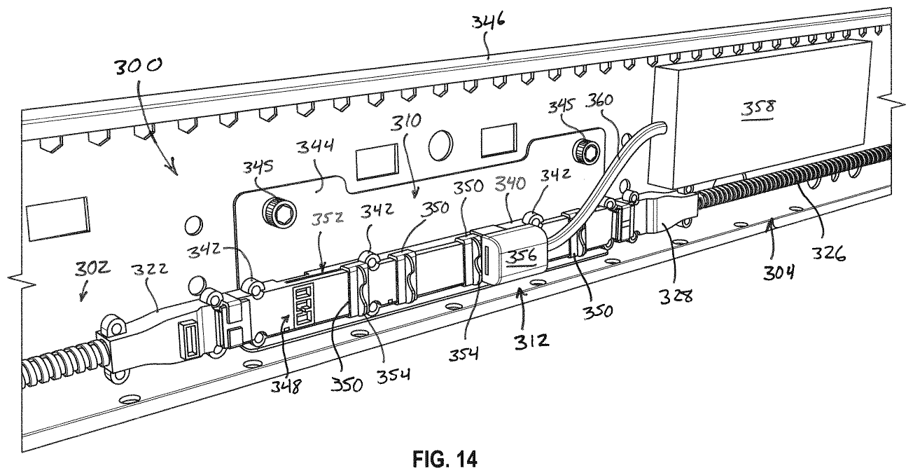

Referring now to FIGS. 13 and 14, another low voltage DC distribution system 300 includes a male jumper assembly 302, a female jumper assembly 304, a bus bar section 310, and a set of branch power couplers 312. Male jumper assembly 302 includes an armored cord section 320 fitted with a male jumper connector 322 and an opposite jumper connector 324, while female jumper assembly 304 includes an armored cord section 326 fitted with at least a female jumper connector 328 for connection to a male connector 330 at one end of the bus bar section 310. Male jumper assembly 302 and female jumper assembly 304 may be identical to one another and therefore interchangeable, with female jumper connector 328 being the same as opposite jumper connector 324 of male jumper assembly 302, and male jumper connector 322 being the same as an opposite jumper connector (not shown) of female jumper assembly 304. Thus, either of male jumper assembly 302 and female jumper assembly 304 may serve as a power input cord or a power output cord. Moreover, the male connector 330 of bus bar section 310 may be the same as male jumper connector 322, while a female connector 332 of bus bar section 310, opposite the bus bar section's male connector 330, being the same as female jumper connector 328 of female jumper assembly 304. The arrangement of compatible male and female connectors in the system 300 allows for two or more bus bar sections 310 to be coupled together end-to-end, allows for use of one or more jumper assemblies 302, 304 at desired locations to connect or extend to other and/or longer runs, and makes the system “directional” in that each jumper assembly or bus bar section 310 may only be installed one way.

In the illustrated embodiment, a cover 334 made of resilient material, such as rubber or rubber-like material, is provided for selectively covering the female connector 332 of bus bar section 310 when male jumper connector 322 of male jumper assembly 302 is not attached to the female connector 332. Cover 334 includes a flexible panel portion 334a that attaches to a base region of female connector 332 of the bus bar section 310, and a receiver portion 334b that fits over the terminals of female connector 332. Flexible panel portion 334a may define a rectangular opening that can be slid or stretched past the terminals of female connector 332 for mounting cover 334 to the female connector 332, while receiver portion 334b may define a generally rectangular socket or receiver that is sized and shaped to receive and frictionally engage the female terminals of female connector 332. In this manner, when use of the cover 334 is desired, such as to protect the female terminals of female connector 332 from environmental contaminants, the flexible panel portion 334a may be flexed about 180-degrees so that the receiver portion 334b may be slipped over the female terminals as shown in FIG. 13. It will be appreciated that the same cover 334 may be installed and used at the other female connectors 324, 328 if desired, while the same or slightly modified cover 334 may also be installed and used at the male connectors 322, 330 if desired.

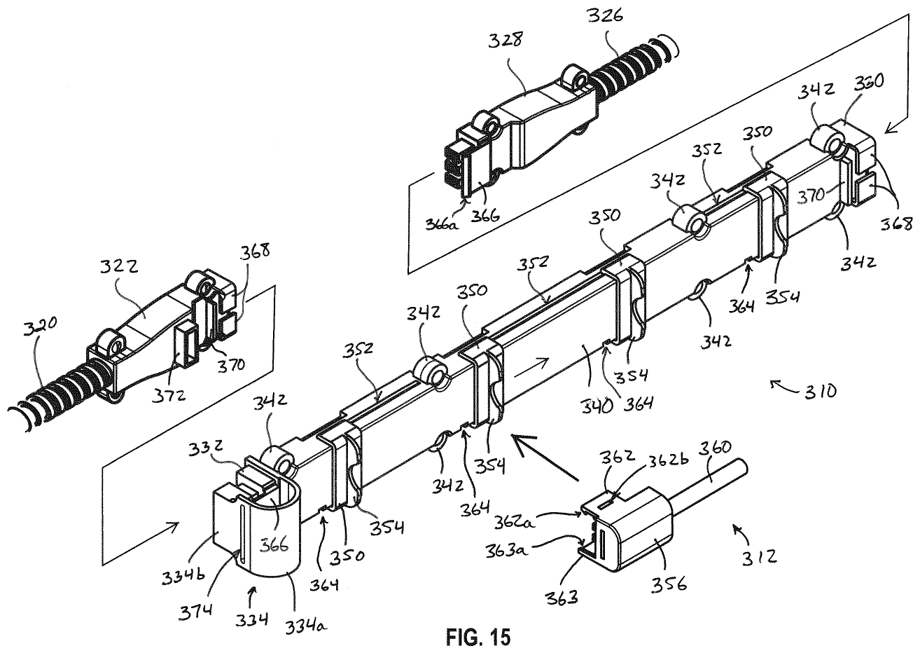

Bus bar section 310 is made up of an outer housing 340 that is generally rectangular in shape, with mounting cars 342 along its length to facilitate attachment to a support panel 344 of a conveyor system rail 346, such as shown in FIG. 14. Support panel 344 may be secured to rail 346 using bolts 345, which are optionally thumbscrews but may be other types of fasteners, and rail 346 may provide multiple mounting locations for support panel 344. Inside of outer housing 340 are a set of electrical bus bars, similar to those described above, which can be selectively exposed at a series of intermediate connector opening sets 348 (FIG. 14). Housing 340 supports a corresponding slide cover 350 for each connector opening set 348. Slide covers 350 are generally C-shaped with opposite ends that are received in respective slots 352 formed on opposite sides of housing 340. An outwardly-extending wall 354 along a central portion of each slide cover 350 facilitates gripping or pushing the slide cover 350 to slide it away from its respective connector opening set 348, as in the left-most slide cover 350 in FIG. 14, or to slide it over its connector opening set 348 as in the second-from-left slide cover 350 and right-most slide cover 350 in FIG. 14. This arrangement allows an operator to easily expose one of the connector opening sets 348 for use, or to cover the connector openings sets 348 when not in use, thus reducing the risk of contaminant intrusion and preventing exposure of live electrical contacts. In FIG. 14, the second-from-right slide cover 350 has been slid to expose its corresponding connector openings set, which is engaged by a 90-degree modular plug connector 356 of a branch power coupler 312 in order to supply power to an embedded conveyor controller (“ECC”) 358 via a power cord 360 of the branch power coupler 312. These actions are represented by arrows in FIG. 15. As can be seen in FIGS. 13-15, the plug connectors 356 each have a latching tab 362 and a keying tab 363. Referring to FIG. 15, latching tab 362 has an inwardly-directed ramped latch 362a along its distal end that can engage the slot 352 on one side of the connector openings set 348, while keying tab 363 has a ridge 363a that extends perpendicularly away from the main portion of connector 356 to be received in a keying feature in the form of a keying slot 364. Securing tab 362 may be sufficiently stiff as to require a tool, such as a flat-bladed screwdriver, to pry the ramped latch 362a out of engagement with the slots 352 and thus permit the plug connector 356 to be removed from engagement with the housing 340 and connector openings set 348. A tool slot 362b (FIG. 15) may be formed in each securing tab 362 to facilitate prying the tab 362 in this manner. Because each bus bar section 310 includes multiple spaced-apart connector opening sets 348 providing access to the bus bars inside outer housing 340, distribution system 300 is readily customized and/or optimized for different applications, available lengths of power cords 360, and the like. For example, to avoid leaving excessive slack in a power cord 360 of a branch power coupler 312, and to avoid having power cord 360 maintained in an overly taught condition, an operator may select any of the four connector opening sets 348 along the length of the outer housing 340

Other features of low voltage DC distribution system 300 include a locking flange 366 at each female jumper connector 328 (FIG. 15). The locking flange 366 has an outwardly-directed ramped latch 366a that slides under a pair of retainer legs 368 of male connector 330 to secure against the retainer legs 368 when fully installed as shown in FIG. 14. An outwardly-extending rib 370 along the male connector 330 (FIG. 15) limits or blocks access to the ramped latch 366a, making it difficult or impossible to depress the ramped latch 366a and release it from retainer legs 368 without use of a tool. This secures the male-to-female connection and reduces the likelihood that an operator will inadvertently separate the connection. The same features may be incorporated into female connector 332 of bus bar section 310 and male jumper connector 322. Similar features are described in commonly-owned U.S. provisional patent application, Ser. No. 63/666,240, filed Jun. 30, 2024, entitled “LOCKOUT TAGOUT BRACKET FOR ELECTRICAL CONNECTORS,” which is hereby incorporated herein by reference in its entirety.

Optionally, male jumper connector 322 includes a rectangular retainer 372 that is spaced from rib 370 and has similar outer shape and dimensions as the terminals of female connector 332, so that the receiver portion 334b of cover 334 may be slid over the retainer 372 and retained there while male jumper connector 322 is coupled with female connector 332. The receiver portion 334b of cover 334 may be retained at female connector 332, when female connector 332 is not engaged by male jumper connector 322, by urging the ramped latch 366a of the female connector's locking flange 366 through a slot 374 formed in the flexible panel portion 334a of cover 334 near receiver portion 334b (FIG. 15).

Thus, the systems allow for adaptable runs of low voltage DC power, and the sections provide access to DC power at multiple points along each section, such as for powering DC motors associated with conveyor systems. The connection interfaces enclose the electrical contacts, and optional shutters provide a tamper-resistant interface.

Changes and modifications in the specifically described embodiments can be carried out without departing from the principles of the present invention which is intended to be limited only by the scope of the appended claims, as interpreted according to the principles of patent law including the doctrine of equivalents.

1. A modular electrical distribution system comprising:
a bus bar section having first and second opposing end connectors that are compatible with one another, and an intermediate connector disposed between said opposing end connectors;
a movable cover selectively disposed over said intermediate connector;
a branch coupler comprising a plug configured for engagement with said intermediate connector when said movable cover is displaced away from said intermediate connector; and
a power supply cord configured for coupling to said first opposing end connector.

2. The modular electrical distribution system of claim 1, wherein said bus bar section comprises an outer housing and a plurality of electrical bus bars disposed in said outer housing, wherein said intermediate connector comprises a plurality of openings formed in said outer housing and providing access to respective ones of said plurality of electrical bus bars.

3. The modular electrical distribution system of claim 2, wherein said outer housing defines a slot for slidably receiving a portion of said movable cover, wherein said movable cover is slidable longitudinally along said outer housing between an open position in which said plurality of openings are exposed and a closed position in which said plurality of openings are covered by said movable cover.

4. The modular electrical distribution system of claim 3, wherein said branch coupler comprises a latch tab configured for selective engagement with said slot defined by said outer housing when said plug engages said intermediate connector.

5. The modular electrical distribution system of claim 4, wherein said branch coupler comprises a keying tab spaced apart from said latch tab, wherein a portion of said keying tab is configured to engage a keying portion of said outer housing located opposite said slot.

6. The modular electrical distribution system of claim 5, wherein said keying tab comprises a ridge and said keying portion of said outer housing comprises a keying slot.

7. The modular electrical distribution system of claim 4, wherein said latch tab comprises a tool slot configured to receive a tool for prying said latch tab away from said outer housing and disengaging said latch tab from said slot.

8. The modular electrical distribution system of claim 1, comprising a plurality of said intermediate connectors and a corresponding plurality of said movable covers in longitudinally spaced arrangement along said outer housing.

9. The modular electrical distribution system of claim 1, further comprising a jumper assembly configured for coupling to said second opposing end connector.

10. The modular electrical distribution system of claim 9, wherein said jumper assembly comprises a jumper connector for coupling to said second opposing end connector, said jumper connector having the same connector interface configuration as said first opposing end connector.

11. The modular electrical distribution system of claim 10, wherein said power supply cord comprises a power supply connector having the same connector interface configuration as said second opposing end connector.

12. The modular electrical distribution system of claim 1, wherein said branch coupler comprises an electrical cord coupled to said plug, said electrical cord configured to supply electrical power to a controller of a conveyor system.

13. The modular electrical distribution system of claim 12, further comprising a support panel configured for attachment to a rail of the conveyor system, wherein said bus bar section is coupled to said support panel.

14. The modular electrical distribution system of claim 13, further in combination with the conveyor system.

15. The modular electrical distribution system of claim 1, wherein said bus bar section comprises a first bus bar section, said system further comprising a second bus bar section identical to said first bus bar section, wherein said bus bar sections at said first opposing end connectors are configured to overlap said bus bar sections at said second opposing end connectors to establish an electrical connection between said first and second bus bar sections.

16. The modular electrical distribution system of claim 15, wherein said first and second bus bar sections cooperate to form a substantially continuous outer surface where one of said first opposing end connectors overlaps one of said second opposing end connectors to establish said electrical connection.

17. The modular electrical distribution system of claim 16, wherein said first and second opposing end connectors are configured to be initially engaged together at a non-parallel angle, and then fully engaged by straightening said first and second bus bar sections into parallel alignment.

18. A modular electrical distribution system comprising:
a conductor section having a rigid elongate housing, first and second opposing end connectors that are compatible with one another, and a plurality of intermediate connectors disposed between said opposing end connectors;
a plurality of covers selectively disposed over respective ones of said intermediate connector;
a branch coupler comprising a plug configured for engagement with any one of said intermediate connectors when said movable cover is displaced away from said intermediate connector;
a first jumper assembly configured for coupling to said first opposing end connector and configured to supply electrical power so said conductor section; and
a second jumper assembly configured for coupling to said second opposing end connector and configured to supply electrical power to another conductor section;
wherein said first jumper assembly is directly coupleable to said second jumper assembly.

19. The modular electrical distribution system of claim 18, further in combination with an electrically powered conveyor system.

20. The modular electrical distribution system of claim 18, wherein:
said conductor section comprises an outer housing and a plurality of electrical bus bars disposed in said rigid elongate housing;
each of said intermediate connectors comprises a plurality of openings formed in said outer housing and providing access to respective ones of said plurality of electrical bus bars;
said outer housing defines a plurality of slots for slidably receiving portion of said movable covers, wherein said movable covers are independently slidable longitudinally along said outer housing between open positions in which said pluralities of openings are exposed and closed positions in which said pluralities of openings are covered;
said branch coupler comprises a latch tab configured for selective engagement with any one of said slots defined by said outer housing when said plug engages one of said intermediate connectors;
said branch coupler comprises a keying tab spaced apart from said latch tab, wherein a portion of said keying tab is configured to engage a keying portion of said outer housing located opposite one of said slots.
